(19) United States
(12) Patent Application Publication
(10) Pub. No.: US 2005/0071978 A1
(43) Pub. Date: Apr. 7, 2005

(54) Conduit end fittings

(76) Inventors: Raymond Nicholas Burke, Bedford, Bedfordshire (GB); Joel Aaron Witz, Newdigate, Surrey (GB)

Correspondence Address: NEEDLE & ROSENBERG, P.C., SUITE 1000, 999 PEACHTREE STREET, ATLANTA, GA, 30309-3915, US

(21) Appl. No.: 10/332,296

(22) PCT Filed: Jul. 5, 2001
(86) PCT No.: PCT/GB01/03022

(30) Foreign Application Priority Data
Jul. 6, 2000 (GB) 0016669.4

(51) Int. Cl. B23P 19/00

(52) U.S. Cl. 29/456

(57) ABSTRACT

A conduit end fitting primarily suitable for terminating high pressure conduits having multiple concentric tube layers, of the kind typically used in the recovery of off-shore hydrocarbon deposits. The fitting comprises inner (10) and outer (20) coaxial tubular elements. The elements are engageable by complementary screw threads (4, 5) and are each provided at their opposite ends with screw threads (6, 8) to engage the conduit (100).

The invention relates to an end fitting for a tubular conduit such as a tube, hose or pipe.

The end fitting may be used for low pressure conduits, but is particularly advantageous as an end fitting which is suitable for terminating high pressure conduits (i.e. those in which the operating pressure of the conduit is typically greater than 50×10⁵ N/m²).

The end fitting is particularly suitable for conduits comprising multiple concentric tube layers; such as the high pressure flexible conduit used in the recovery of offshore hydrocarbon deposits, as discussed in WO 99/57475. In this case, the multiple layer conduit has one or more of the layers formed from helically wound components (windings).

End fittings may be releasably or permanently attached to conduits. Permanent end fittings are known for robust sealing of conduit ends, but have drawbacks in that they often require plastic deformation of the conduit and/or parts of the end fitting. For example, it may be required that the end fitting is crimped onto the pipe. Such end fittings are not re-usable, and the process of attaching the end fitting to the conduit often deforms the conduit.

Releasable end fittings are not available for high pressure conduits. In addition, current releasable end fittings often require a number of components to provide a reliable seal, even when used for low pressure conduits. End fittings are required which can be applied and re-applied, and at the same time provide an effective seal, particularly for high pressure applications.

For conduits formed from multiple concentric layers, each layer is often terminated separately, making conduit termination an awkward and time consuming activity. For example, the current end fittings used to terminate the above mentioned offshore hydrocarbon recovery flexible conduits require separation of the conduit layers, and rely on bending tensile wire layers over an internal surface of the end fitting. This procedure substantially holds the end fitting onto the conduit. An epoxy-resin also needs to be applied around these deformed tensile wire layers to both provide a seal, and also to hold the wire layers within the end fitting under conduit loading.

According to the present invention there is provided a conduit end fitting comprising inner and outer co-axial tubular elements engageable by complementary screw threads at one end and each provided at their opposite ends with screw threads to engage, in use, a conduit.

An end fitting which can engage with a feature of the conduit is provided. The screw thread engagement ensures that the end fitting does not damage the conduit or any component layers thereof, transmits load over a substantial area, and can be removed and re-applied to the conduit. There is no need to crimp the end fitting onto the conduit and thus plastic deformation of the conduit and/or end fitting is avoided.

The two-part fitting provides an end fitting which transmits loads over a substantial area, and terminates and can seal the pipe. As the elements are engageable with both the conduit and with one another, service loads are distributed between the elements at more than one location and across a substantial area, and the maximum load seen at any one element location is reduced.

The invention also extends to a combination of the end fitting and a tubular conduit formed from a helical winding wherein turns of the helical winding define a helical thread on at least an outer or inner surface of the conduit for engagement with one of the screw threads at the opposite end of the end fitting.

Preferably the conduit has a second helical winding having a complementary helical thread to engage with the other screw thread at the opposite end of the end fitting.

The outer element may have a thicker cross section at the conduit end than at the inter-connecting end, and/or the inner element may have a thicker cross section at the inter-connecting end than at the conduit end. This ensures that a sufficient thickness of the elements is available where it is most required. Preferably, the cross section of the elements tapers from one end to the other end. This enables gradual take up of load across the elements.

Advantageously, the screw thread at the one end is contra-helical to the threads at the opposite end. Therefore, loosening engagement of the threads between the conduit and the end fitting will tighten engagement of the threads of the elements at the inter-connecting end, and vice versa. At least one end will be engaged regardless of the direction of relative rotation, and the end fitting can be used in dynamic situations in which relative rotation of elements in both directions is likely to occur, such as in the recovery of offshore hydrocarbons. In certain circumstances, for example when the end fittings are used with low pressure conduits, this is sufficient to maintain an effective seal, and prevent substantial leakage of fluid from the conduit, or ingress of fluid into the conduit.

Preferably, the inner and/or outer elements have at least one shoulder located to abut at least one layer of the conduit. The shoulder gives a sealing surface.

In certain circumstances, particularly when used with high pressure conduits, the end fitting will require a sealing element to provide an extra barrier to prevent fluid leakage out of/into the conduit. Preferably, the end fitting comprises an annular sealing element positioned between the inner and outer elements. Preferably, one or both of the inner and outer elements have a shoulder on which the sealing element surfaces abut.

Advantageously, the end fitting comprises an energising element to ensure that the sealing element is sufficiently compressed to provide an adequate seal. The energising element is positioned in the end fitting to be movable to set the sealing element.

The inner and/or outer elements may comprise complementary key slots positioned to ensure that they are correctly circumferentially aligned.

The invention also provides a method of fitting the inner and outer co-axial elements to the tubular conduit, comprising the steps of screwing the outer element conduit end screw thread onto the outer winding helical thread until the outer element inter-connecting end is positioned to allow access for the inner element to the conduit, screwing the inner element conduit end screw thread onto the inner winding helical thread, and screwing the outer element back to connect the inter-connecting ends of the inner and outer elements.

The conduit end fitting can be used for conduits which operate at pressures less than 50×10⁵ N/m². However, it is also particularly suitable for conduits which operate at pressures of at least 50×10⁵ N/m², preferably at least 100×10⁵ N/m², more preferably at least 150×10⁵ N/m², and most preferably at least 200×10⁵ N/m². The conduit end fitting is suitable for the high pressure flexible conduits used in offshore hydrocarbon recovery, of the types described in WO 99/57475.

The invention will now be described in detail with reference to the following Figures in which:

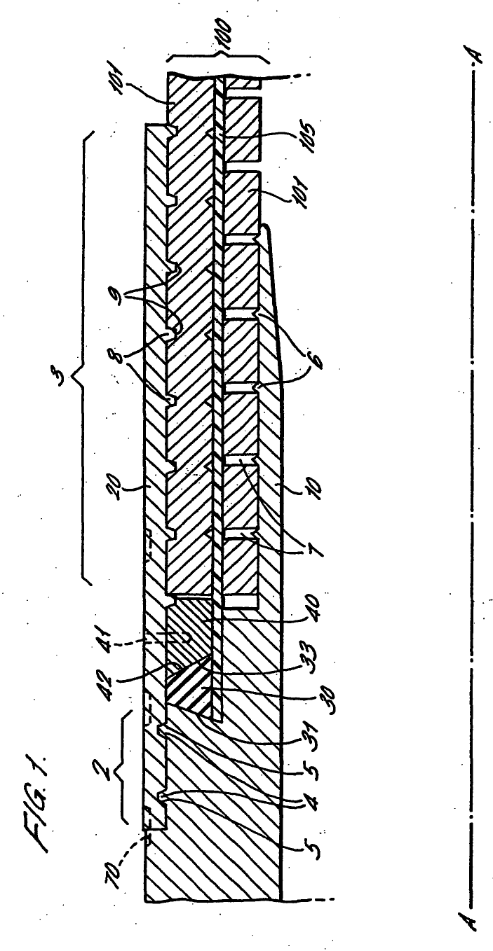

FIG. 1 is a cross-section of an end fitting according to the present invention engaged with a multilayer high pressure conduit;

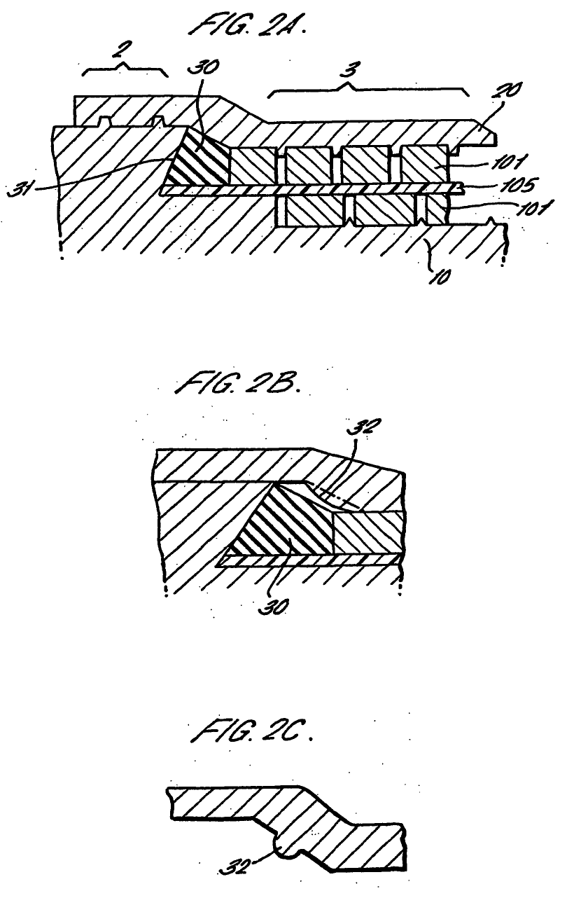

FIG. 2A is a cross-section of an end fitting according to the present invention engaged with a multilayer conduit;

FIG. 2B is an exploded view of a portion of FIG. 2A;

FIG. 2C is an exploded view of a portion of an outer element of the end fitting of the present invention;

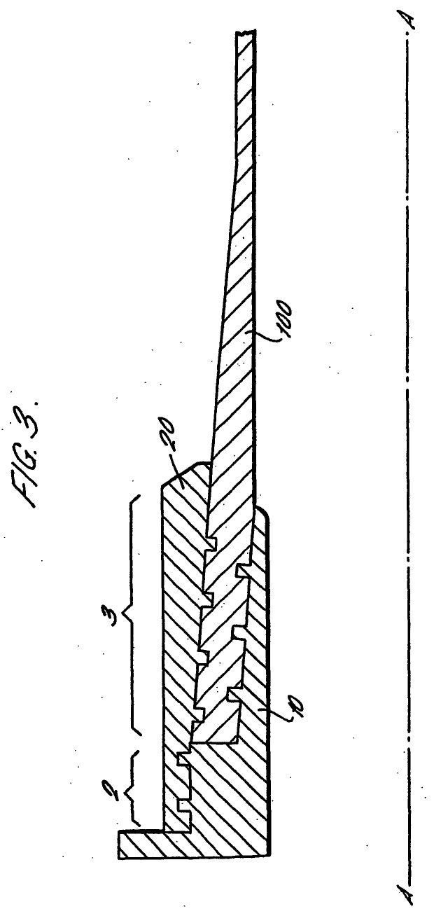

FIG. 3 is a cross-section of the end fitting according to the present invention engaged with a single layer conduit;

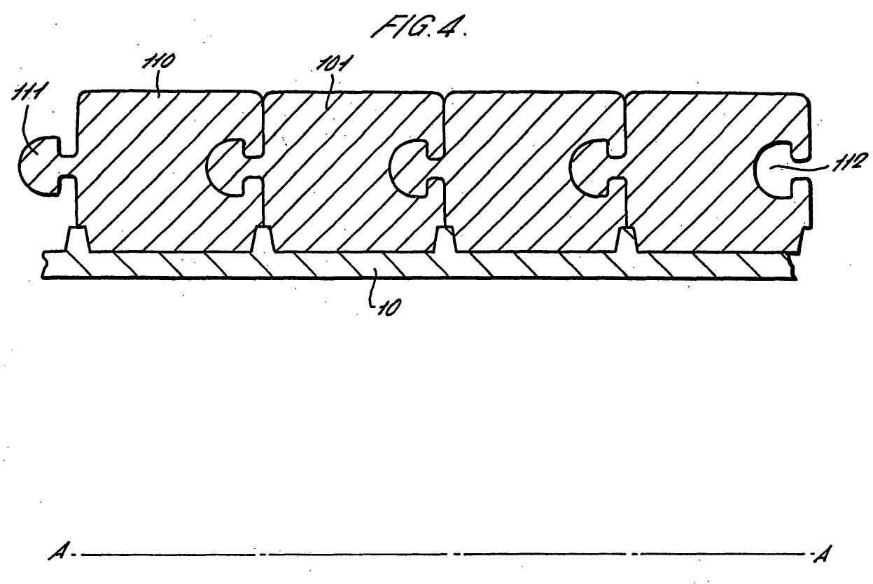

FIG. 4 is a cross-section of the conduit end portion of an end fitting of the present invention engaged with a particular high pressure capacity conduit winding;

The figures show only half the end fitting/conduit cross section on one side of the end fitting/conduit axis A-A of symmetry.

Although the description relates particularly to high pressure end fittings, the end fitting described can be applied to low pressure conduits also. The end fittings can be made of any material which provides the required structural strength and has the required machinability/formability e.g. steel for high pressure end fittings.

High pressure conduits 100 are often reinforced by helically wound armour 101 which is profiled to allow each subsequent turn to interlock with the previous turn. Such structures are compliant in flexure. Generally, the armour is formed from steel or composite strip. An example of this type of tubular conduit is un-bonded flexible conduit, used in the recovery of offshore hydrocarbon deposits.

FIG. 1 shows a first embodiment of the end fitting 1 for terminating such a flexible conduit 100. The flexible conduit 100 is formed from a number of co-axial layers; two helically wound layers 101 between which is an extruded polymer sealing layer 105. The sealing layer 105 may of course be made from a metallic or composite material or may be made from other known processes.

A helical groove 7,9 is defined between adjacent turns of the helical winding 101, and can be conveniently used to engage with the end fitting 1. In a different configuration, the polymer sealing layer 105 may be inscribed with one or more helical grooves on inner and/or outer surfaces for engagement with the end fitting 1. Furthermore, although FIG. 1 shows a conduit 100 comprising more than one layer, the end fitting 1 can be fitted to a conduit 100 comprising only a single layer, as shown in FIG. 3. This single layer can be the extruded polymer layer 105 or a single helical winding 101, again with grooves on the inner and/or outer surface for engagement with the end fitting 1.

The end fitting 1 comprises inner and outer co-axial tubular elements 10,20. The end fitting 1 has a first end 2 at which the elements 10,20 releasably engage with one another, and an opposite second end 3 at which the elements 10,20 releasably engage with the conduit 100. The distance between the first and second ends 2,3 is typically at least twice the pitch of the thread on the conduit 100.

The first end 2 comprises a first helical thread 4 on a outer surface of the inner element 10, and a complementary first helical thread 5 on a inner surface of the outer element 20. In a different embodiment, the helical threads 4 and 5 may be respectively on inner and outer surfaces of the elements 10,20 (not shown). The essential point for the position of the first helical threads 4,5 is that they are engageable with one another, and thus join/seal the end fitting 1 at the first end 2.

At the second end 3, the inner element 10 has a second helical thread 6 on a outer surface of the inner element 10. The second helical thread 6 engages with a helical thread 7 on a inner layer of the conduit 100. Similarly, the outer element 20 has a second helical thread 8 on the inner surface of the element 20 which engages with a helical thread 9 on a outer layer of the conduit 100. In the embodiment shown in FIGS. 1,2 the conduit helical threads 7,9 are defined by turns of helical windings 101, and have different pitches. Alternatively, the threads 7,9 may have the same pitch.

In an alternate embodiment, the second helical threads 6,8 on the elements 10,20 may be on the inner and outer surfaces of their corresponding elements 10,20, with the complementary conduit threads 7,9 positioned appropriately. The conduit threads 7,9 may be on inwardly or outwardly facing surfaces of the conduit, as long as the conduit thread 7 is positioned inwardly of the conduit thread 9.

The threads 4,5, and 6,7,8,9 at the first and second ends 2, 3 of the elements 10,20 are of the same pitch. Thus, both ends 2,3 of the end fitting 1 may be engaged by relative rotation of the elements 10,20 (see assembly, discussed below).

Thread engagement can advantageously seal fluid flow and allows engagement of the end fitting 1 to the conduit 100 without the need to plastically deform the conduit 100 or the end fitting 1. The threads 4,5, 6,7,8,9 provide a form of labyrinth seal which, particularly in low pressure applications, would not necessitate the need for other sealing elements such as “O” rings.

In another embodiment, the outer element 20 has a thicker cross section at the second end 3 than at the first end 2, and/or the inner element 10 has a thicker cross section at the first end 2 than at the second end 3 (FIG. 3). This ensures that a sufficient thickness of the elements is available where it is most required. The cross section of the elements 10,20 taper from the thicker end to the thinner end to enable gradual take up of load across the elements 10,20, and avoids stress concentrations. The combined cross section of the tapered inner and outer elements 10,20 provide an end fitting 1 with a constant thickness (FIG. 3).

When used with multi-layer conduits 100 which have at least one sealing layer 105, one or more of the sealing layer(s) 105 may be used to abut against one or more shoulders 31 on one or more of the element(s) 10,20. Thus, abutment of the sealing layer(s) 105 on the element shoulder(s) 31 would seal the conduit 100 within the end fitting 1, and inhibit leakage of fluid.

The first and second end threads 4,5 and 6,7,8,9 are contra-helical such that relative rotation of the elements 10,20 will maintain engagement of the end fitting 1 on the conduit 100 at either the first or second end 2,3. For example, from the perspective of looking down the conduit wall, one helix will appear clockwise (or right hand lay) and the other will appear anti-clockwise (or left hand lay). Thus, rotational torsion of the conduit 100 will not cause the end fitting 1 to unscrew or vice-versa.

A sealing element 30 is provided as a barrier to prevent fluid leakage out of/into the conduit 100, and is positioned between the inner and outer elements 10,20. The sealing element 30 may be a ring, hoop or split ring. A shoulder 31,32 is provided on the inner and/or outer elements 10,20 on which the sealing element 30 may abut (FIGS. 1 and 2). The shoulders 31,32 may be inclined or curved (FIGS. 2A, 2B) to facilitate sealing between the sealing element 30 and the shoulders 31,32.

It would be advantageous to have end fittings 1 which have a simple means for energising the seal element 30 to a required amount, and then adjusting and re-adjusting the sealing element 30 during operation and maintenance. It is important to note that energisation of a seal was previously developed by trial and error, and involves plastic deformation of components, and a consequent margin of uncertainty. In the end fitting 1 presented herein, the sealing element 30 is energised against a solid segment of the inner element 10. Furthermore, the relative displacement between two mechanical elements 10,20 should involve elastic deformation only, which can be precisely modelled.

Advantageously, the end fitting 1 comprises an energising element 40 to ensure that the sealing element 30 is sufficiently compressed to provide an adequate seal. The energising element 40 is positioned in the end fitting 1 such that at least one energising element surface 42 is adjacent to and abuts with at least one surface 33 of the sealing element 30.

The energising element 40 is controllably compressable and depressable by means of a screw housed in an radial aperture 41 of the outer element 20. The aperture 41 may extend into the energising element 40.

The end fitting inner and/or outer elements may comprise key slots 70 positioned to ensure that the inner and outer elements 10,20 are circumferentially aligned, and stay aligned during operation. The key slots 70 are also positioned so that the elements can be locked into position once the sealing element has been correctly energised. For example, the key slots 70 may be located every 30 degrees around the circumference of the inner and/or outer elements 10,20.

The multilayer conduit 100 is prepared for assembly by cutting back the layers 101,105 to expose the internal and external layers which have the threads 7,9, and also the intervening sealing layer 105. The outer element 20 is then threaded onto the outer conduit thread 9 and turned until it has travelled some way down the conduit length. The sealing element 30 and energising element 40 are placed in position. Then, the inner element 10 is threaded onto the inner conduit thread 7. Grub screws or pins are inserted through the outer element aperture 41 onto the energising element 40 and hold the energising element 40 into position. The inner element 10 is rotated to eliminate any gaps between the components 30, 40 of the end fitting 1 and also the sealing layer 105. Finally, the outer element 20 is rotated so as to bring it back to engage the first threads 4,5 of the end fitting 1. Back rotation of the outer element 20 towards the free end of the conduit 100 will also compress and energise the seal.

The description above has discussed embodiments of end fittings 1 having both inner and outer elements 10,20. However, the end fitting 1 may only have a single inner 10 or outer element 20. Such single element end fittings 1 would be particularly suitable for the high pressure capacity windings discussed in WO 99/57475 (FIG. 4). Such windings comprise a body 110 which have one or more axially extending projections 111 on one or more radial sides, and a corresponding number of complimentary sockets 112 on one or more opposing radial sides. The increased strength of such windings can support the single element end fittings when used in high pressure applications. The end fitting 1 is also suitable for engagement with other forms for interlocked helical windings, such as the “Z”, “T”, “C” and “S” type windings mentioned in WO99/57475 and used in offshore hydrocarbon recovery. As the structural strength of such windings is relatively poor, the end fitting 1 would preferably comprise an inner element 10 which engages with one winding and an outer element 20 which engages with a different winding.

1-8. (canceled)

9. A conduit end fitting comprising inner and outer co-axial tubular elements engageable by complementary first screw threads at one end and each provided at their opposite ends with second screw threads to engage, in use, a conduit.

10. The conduit end fitting of claim 9 suitable for conduits with operating pressures preferably of at least 50×10⁵ N/m², more preferably at least 100×10⁵ N/m², more preferably at least 150×10⁵ N/m², and most preferably at least 200×10⁵ N/m².

11. The conduit end fitting of claim 9, further comprising a tubular conduit formed from a helical winding wherein turns of the helical winding define a helical thread on at least an outer or an inner surface of the conduit for engagement with one of the second screw threads at the opposite end of the conduit end fitting.

12. The conduit end fitting of claim 11, wherein the conduit has a second helical winding having a complementary helical thread to engage with the second screw head at the opposite end of the end fitting.

13. The conduit end fitting of claim 11, wherein the outer element has a thicker cross section at the conduit end than at the inter-connecting end, and/or the inner element has a thicker cross section at the inter-connecting end than at the conduit end.

14. The conduit end fitting of claim 13, wherein the cross section of the respective elements tapers from one end to the other end.

15. The conduit end fitting of claim 11, wherein the first screw thread at the one end is contra-helical to the second screw threads at the opposite end thereof.

16. The conduit end fitting of claim 11, wherein each of the inner and the outer elements has at least one shoulder positioned to abut at least one layer of the conduit.

17. The conduit end fitting of claim 11, further comprising an annular sealing element positioned between the inner and outer elements.

18. The conduit end fitting of claim 17, wherein the end fitting comprises an energising positioned in the end fitting to be movable to set the sealing element.

19. The conduit end fitting of claim 10, wherein the inner and/or outer elements comprise complementary key slots positioned to ensure that they are correctly circumferentially aligned.

20. A method of assembling the conduit end fitting of claim 12, comprising the steps of screwing the outer element conduit end screw thread onto the outer winding helical thread until the outer element interconnecting end is positioned to allow access for the inner element to the conduit, screwing the inner element conduit end screw thread onto the inner winding helical thread, and screwing the outer element back to connect the inter-connecting ends of the inner and outer elements.
